(19) United States
(12) Patent Application Publication
(10) Pub. No.: US 2018/0299008 A1
(43) Pub. Date: Oct. 18, 2018

(54) VEHICLES, ELECTRONIC CONTROL UNITS, AND METHODS FOR GEAR SHIFTING BASED ON VEHICLE ATTITUDE

(71) Applicant: Toyota Motor Engineering & Manufacturing North America, Inc., Erlanger, KY (US)

(72) Inventor: Erik Anthony Wippler, Canton, MI (US)

(73) Assignee: Toyota Motor Engineering & Manufacturing North America, Inc., Erlanger, KY (US)

(21) Appl. No.: 15/487,496

(22) Filed: Apr. 14, 2017

(51) Int. Cl. F16H 61/02

(52) U.S. Cl. CPC F16H 61/0213; F16H 2059/666; F16H 2061/0237; F16H 2061/0216

(57) ABSTRACT

A vehicle includes an engine, a plurality of drive wheels, a vehicle transmission configured to transmit power from the engine to the plurality of drive wheels, one or more vehicle attitude sensors, and an electronic control unit communicatively coupled to the one or more vehicle attitude sensors and the vehicle transmission. The electronic control unit is configured to receive a signal from the one or more vehicle attitude sensors, determine a degree of vehicle descent based on the signal received from the one or more vehicle attitude sensors, and downshift the vehicle transmission based on the degree of vehicle descent determined based on the signal received from the one or more vehicle attitude sensors.

### TECHNICAL FIELD

The present specification relates to vehicles, electronic control units, and methods for gear shifting based on vehicle attitude.

### BACKGROUND

Many vehicles include an automatic transmission. Generally, an automatic transmission automatically upshifts or downshifts based upon a particular transmission schedule and vehicle load. When a vehicle enters an uphill or downhill slope, the load on the engine may increase or decrease, respectively, as the effects of gravity act on the vehicle. Accordingly, in some situations, it may be advantageous for a vehicle to shift gears depending on the grade of the terrain on which the vehicle is driving.

### SUMMARY

In one embodiment, a vehicle includes an engine, a plurality of drive wheels, a vehicle transmission configured to transmit power from the engine to the plurality of drive wheels, one or more vehicle attitude sensors, and an electronic control unit communicatively coupled to the one or more vehicle attitude sensors and the vehicle transmission. The electronic control unit is configured to receive a signal from the one or more vehicle attitude sensors, determine a degree of vehicle descent based on the signal received from the one or more vehicle attitude sensors, and downshift the vehicle transmission based on the degree of vehicle descent determined based on the signal received from the one or more vehicle attitude sensors.

In another embodiment, an electronic control unit for a vehicle is configured to receive a signal from one or more vehicle attitude sensors, determine a degree of vehicle descent based on the signal received from the one or more vehicle attitude sensors, and downshift a vehicle transmission based on the degree of vehicle descent determined based on the signal received from the one or more vehicle attitude sensors.

In yet another embodiment, a method for downshifting a vehicle transmission configured to transmit power from an engine to a plurality of drive wheels includes receiving a signal from one or more vehicle attitude sensors, determining a degree of vehicle descent based on the signal received from the one or more vehicle attitude sensors, and downshifting the vehicle transmission based on the degree of vehicle descent determined based on the signal received from the one or more vehicle attitude sensors.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a vehicle having a transmission and an electronic control unit for automatically shifting the transmission according to one or more embodiments shown and described herein;

FIG. 2 schematically depicts a transmission shifting electronic control unit and various connected systems of the vehicle of FIG. 1;

FIG. 3 depicts a flow chart illustrating a method of downshifting the vehicle of FIG. 1 based on a signal generated by an attitude sensor;

FIG. 4 schematically depicts the vehicle of FIG. 1 encountering various scenarios and road slopes to describe the functionality of the electronic control unit and other systems of FIG. 2; and

FIG. 5 schematically depicts the vehicle of FIG. 1 approaching various road conditions, according to one or more embodiments shown and described herein.

### DETAILED DESCRIPTION

Embodiments of the present disclosure are directed to vehicles, electronic control units, and methods for gear shifting based on vehicle attitude. On significant downhill slopes, the force of gravity may act on the vehicle to undesirably accelerate the vehicle down the slope. In this scenario, it may be advantageous to shift the engine to a lower gear (i.e., “downshift”) to increase the ratio between the rotational velocity of the drive wheels and the rotational velocity of the engine so that the rotating components of the engine and drivetrain act as a load upon the drive wheels (i.e., “engine brake”). This engine braking may slow the vehicle's descent. In turn, less friction braking force may be required to slow the vehicle. In some embodiments, electronic control units may receive a signal from one or more vehicle attitude sensors, determine a degree of vehicle descent based on the signal received from one or more vehicle attitude sensors, and downshift the vehicle transmission based on the degree of vehicle descent determined based on the signal received from one or more vehicle attitude sensors, thereby resulting in less brake wear and allowing the use of smaller brake components, which reduces vehicle weight. Various embodiments of vehicles, electronic control units, and methods for gear shifting based on vehicle attitude will now be described.

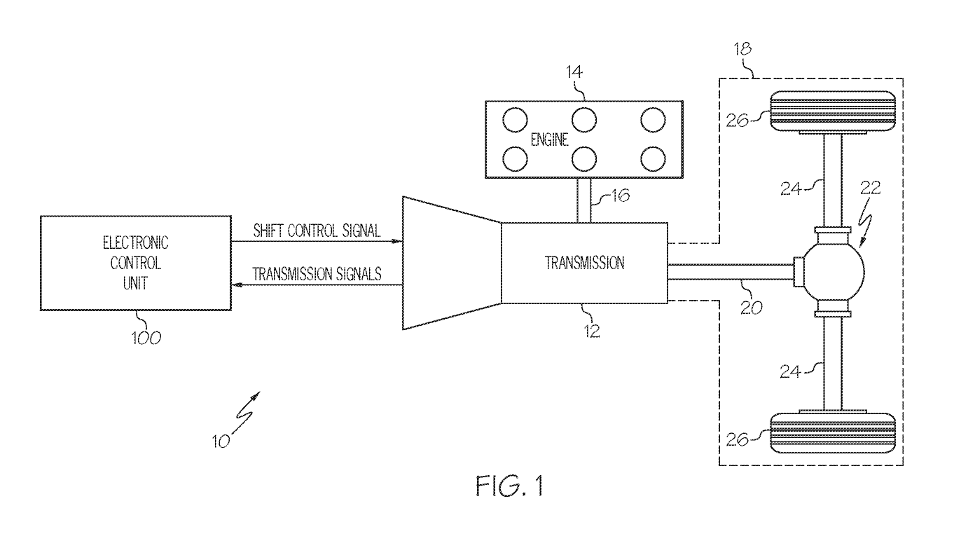

FIG. 1 illustrates a portion of a vehicle 10 having a transmission 12 (for the purposes of this application, the terms “transmission” and “vehicle transmission” may be used interchangeably). Embodiments of the vehicle 10 comprise the transmission 12, an engine 14, an output shaft 16, and a drive train 18 comprising one or more drive shafts 20, one or more differentials 22, one or more axles 24, and one or more drive wheels 26. The transmission 12 may be electronically coupled to and controlled by an electronic control unit (ECU) 100.

The engine 14 may couple to various components of the drive train 18 through the output shaft 16 and the transmission 12. The engine 14 provides rotational velocity to the transmission 12 through the output shaft 16 at a given rotational velocity (revolutions per minute (“RPM”)). The engine 14 may be any type of reciprocating or rotational device, such as, for example, a gasoline-fired piston engine, a diesel engine, an electric motor, or any other device for imparting torque to rotate a shaft. As discussed below, the transmission 12 may be operable to change the ratio of the rotational velocity between the engine 14 and one or more components of the drive train 18, such as the one or more drive wheels 26, as the velocity of the vehicle 10 changes.

In one embodiment, the transmission 12 may be an automatic transmission commonly used in automobiles. The transmission 12 may comprise sets of discreet, selectable gears capable of being engaged to change the proportion of engine RPM to drive train RPM through the transmission 12. In some embodiments of the transmission 12, the gears are planetary gears, but embodiments are not so limited. Each discreet ratio between engine RPM and drive train RPM may be defined as a particular gear ratio. Some embodiments of the transmission 12 include a torque converter for shifting between consecutive gear ratios during vehicle operation. In some embodiments, the torque converter may momentarily disengage the engine 14 from the transmission 12 to permit a gear ratio change to occur. Of course, the transmission 12 may be provided with particular gear sets and gear ratios different from the embodiments described above. Furthermore, in other embodiments, other transmissions may be implemented such as a shift-assisted manual transmission, continuously variable transmissions, and the like.

As illustrated, the drive train 18 may comprise a differential 22, a drive shaft 20 and the axles 24 for providing rotational velocity from the transmission 12 to the drive wheels 26. In such embodiments, rotational velocity from the transmission 12 may be provided to the axles 24, through the differential 22 and the drive shaft 20, to the drive wheels 26. It should be understood that such an embodiment is merely illustrative and other embodiments may be configured according to particular vehicle specifications or designs. For instance, some embodiments of the drive train 18 may comprise two differentials, two drive shafts, and four axles for providing rotational velocity from the transmission 12 to four wheels, such as on a 4-wheel-drive vehicle. Furthermore, the drive train 18 may be configured to drive any number of wheels such as six wheels (e.g., an ATV), four rear wheels (e.g., a tractor trailer), one wheel (e.g., a motorcycle) or any other number of drive wheels for driving a given vehicle. Consequently, it should also be understood that the configuration of the drive train 18 is illustrative and may be configured according to particular vehicle specifications or designs. For instance, in some vehicles, the transmission 12 may be coupled directly to the axles 24, thereby eliminating the need for the drive shaft 20 and the differential 22. Similarly, in some vehicles, additional transmissions may be implemented and coupled directly to the axles 24 thereby eliminating the need for the drive shafts 20 and the differentials 22.

The engine 14 may be coupled with the transmission 12 through the output shaft 16 such that the engine 14 may rotate the output shaft 16 at a given rotational velocity to provide rotational velocity to the transmission 12. The engine 14 may be an internal combustion engine, but other embodiments may be provided such as a steam engine, an electric motor or the like. As is common in many vehicles, a user may selectively control vehicle speed by controlling the rotational velocity of the engine 14 (e.g., varying an engine throttle). In one embodiment, the user may vary engine rotational velocity by depressing an accelerator pedal. However in other embodiments, the user may vary the rotational velocity by engaging a knob, a lever, a trigger, or any other device for enabling a user to vary engine rotational velocity. As is common in vehicles, the engine 14 may operate within a finite range of rotational velocities (e.g., 0-6,000 RPM) capable of driving a vehicle at low speeds. The transmission 12 may proportionally change the rotational velocities provided by the engine 14 by implementing the selectable gear ratios described above. In particular, the engine 14 may operate within its finite range of rotational velocities for each gear ratio such that each particular gear ratio may correspond to a particular range of vehicle speed. For instance, engine rotational velocities for a first gear ratio may provide vehicle speeds from zero to ten miles per hour (MPH), engine rotational velocities for a second gear ratio may provide vehicle speeds from ten MPH to twenty MPH, engine rotational velocities for a third gear ratio may provide vehicle speeds from twenty MPH to forty MPH, etc. It should be understood that other configurations are contemplated having any number of gear ratios, gear ratios having different ranges of speed or other gear ratio configurations suitable for corresponding engine rotational velocity to vehicle drive wheels.

In some embodiments, the transmission 12 comprises a shift controller configured to provide hydraulic pressure to the transmission 12 to select between gear ratios. As is common in transmissions, a gear ratio may be selected when a particular hydraulic pressure is achieved within the transmission 12. The shift controller may regulate the flow of transmission media (i.e., automatic transmission fluid, transmission oil, hydraulic fluid, or the like) by controlling a shift valve to select a particular shift point. It should be understood that the example of a hydraulic shift controller is merely illustrative and other embodiments are contemplated. For instance, the shift valve may be electronically controlled. In such an embodiment, vehicle conditions may be monitored to determine whether a transmission shift is appropriate. When the logic appropriate shift point is determined (i.e., through algorithms, lookup tables stored in memory or the like), the shift valve may be controlled to regulate transmission media to shift the transmission 12.

As a vehicle changes speeds, shift points may be selected to initiate gear ratio change(s). Shift points may be determined based upon vehicle conditions (i.e., engine rotational velocity, engine torque, vehicle speed, vehicle weight, acceleration, deceleration, environmental conditions, or road conditions and the like). Particular shift points may be assigned based upon limits associated with the conditions. When the limits of a particular condition are achieved (i.e., shift point achieved) a gear ratio change may occur. Accordingly, as used herein, a “shift” refers to a gear ratio change.

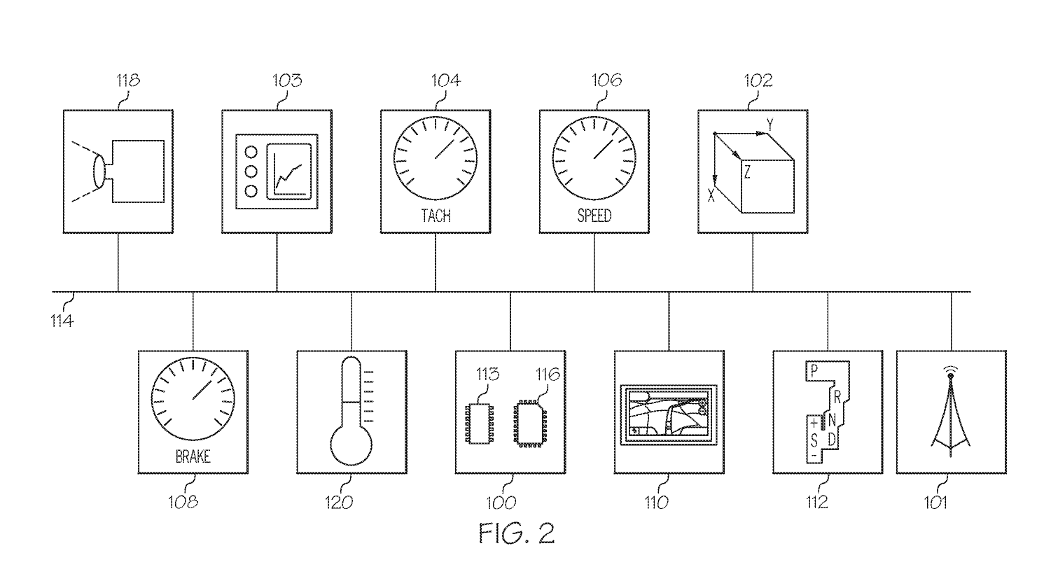

Shift points may be selected using calculation/selection methods now known or hereafter developed. In one embodiment, shift points may be calculated using predefined algorithms or programs or firmware associating shift points with particular condition limits. In another embodiment, shift points may be selected from a lookup table associating shift points with particular condition limits. In yet another embodiment, shift points may be selected from storage in one or more memory modules 113 communicatively coupled to the transmission shifting electronic control unit (“ECU”) 100 (see FIG. 2) when a particular condition limit value is achieved. Various other embodiments are contemplated wherein shift points may be based upon conditions, such as vehicle attitude, and may be calculated in manners which may comport with a particular vehicle or transmission configuration.

In one embodiment, a shift point may be determined based upon engine rotational velocity. As described above, the engine 14 may be capable of operation within a range of rotational velocities having an upper and lower limit (e.g., 0-6,000 RPM). Shift points may be assigned based upon the upper and lower engine rotational velocity limits to ensure the engine 14 operates within a given rotational velocity range during vehicle operation. For instance, a shift point may be selected for an upper rotational velocity limit where, upon reaching the particular shift point (e.g., during vehicle acceleration), a higher gear ratio may be selected and the rotational velocity of the engine 14 may be decreased (i.e., upshift) while the vehicle speed (i.e., the rotational velocity of the drive wheels) remains constant. Conversely, a shift point may be selected for a lower rotational velocity limit where, upon reaching the particular shift point (e.g., during a downhill stretch when the vehicle may accelerate without increasing the throttle position), a lower gear ratio may be selected and the rotational velocity of the engine 14 may be increased (i.e., downshift). It should be understood that upper and lower rotational velocity limits may be breached as a vehicle accelerates or decelerates. Therefore, shift points may be selected for different gear ratios to ensure proper engine operation during vehicle acceleration and deceleration.

In another embodiment, a shift point may be determined based upon vehicle speed and accelerator depression. As a vehicle operates, a user may indicate a desire to accelerate a vehicle by depressing an accelerator pedal. Since vehicle acceleration may be easier to achieve at high engine rotational velocities, a particular shift point may be assigned to allow the engine 14 to reach a high rotational velocity. For instance, substantial pedal depression may indicate a desire to quickly increase vehicle speed. A shift point may be assigned wherein gear shift is delayed and the engine 14 achieves a high rotational velocity to provide additional acceleration. Conversely, because the engine braking force may be greater when engine braking at higher engine RPM, a downshift point may be assigned wherein gear shift is hastened depending on the rate of change of vehicle attitude to provide additional engine braking force.

As used herein, the term “engine braking force” is that force which is created by retarding forces within the vehicle's engine and drive train, as opposed to other braking forces created by, for example, friction brakes, that slow the velocity of the vehicle in a direction opposite the direction of travel. This may result, for example, in gasoline engines when the accelerator is released thereby shutting one or more air intake valves, restricting airflow to the one or more pistons, and resulting in a high manifold vacuum through the intake. Other sources of engine braking force may include friction forces within the engine and drive train, such as the friction between the one or more pistons and the cylinders.

As illustrated in FIGS. 1 & 2, the transmission shifting ECU 100 may be provided to control the transmission 12 based upon vehicle condition data (e.g., vehicle data, transmission data, environmental data, user-provided data or any other data which may support transmission control). The transmission shifting ECU 100 includes one or more memory modules 113 and one or more processors 116.

The transmission shifting ECU 100 is communicatively coupled to the transmission 12 to provide control signals to the transmission 12. Additionally, and as shown in FIG. 2, the transmission shifting ECU 100 may be communicatively coupled to network interface hardware 101, one or more attitude sensors 102, a user preferences module 103, a tachometer 104, a speedometer 106, a brake meter 108, a GPS 110, a transmission status relay 112, one or more road condition sensors 118, and one or more weather condition sensors 120 through a communication path 114.

The transmission shifting ECU 100 may comprise one or more processors 116 to process data. Such processors may calculate shift points, control routines, optimize schemes, perform error correction, calculate protection schemes or process data in any other manner to support transmission control. Each of the one or more processors 116 of the transmission shifting ECU 100 may be any device capable of executing the logic described herein. Accordingly, each of the one or more processors 116 may be a controller, an integrated circuit, a microchip, a computer, or any other computing device. In some embodiments, each of the one or more processors 116 may be configured to execute machine-readable instructions to carry out the logic described herein. In some embodiments, at least one of the one or more processors 116 is hard coded to perform at least a portion of the logic described herein.

In one embodiment, the transmission shifting ECU 100 may calculate transmission shift points based upon vehicle condition data and may control the transmission 12 based upon such shift points. The various transmission shift points may be referred to as a “shift schedule.” In another embodiment, the transmission shifting ECU 100 may provide shift inhibition routines by monitoring vehicle and environmental conditions such as braking, precipitation, temperature or wind speed to determine whether a transmission shift may cause undesirable vehicle performance, such as, for example, the engine exceeding an RPM limit. In yet another embodiment, the transmission shifting ECU 100 may control the transmission 12 by querying a user to provide information or one or more preset user preferences and controlling the transmission 12 based upon such information.

The one or more processors 116 may be communicatively coupled to the other components of the vehicle 10 through the communication path 114. Accordingly, the communication path 114 may communicatively couple any number of processors with one another, and allow the components coupled to the communication path 114 to operate in a distributed computing environment. Specifically, each of the components may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

The communication path 114 may be formed from any medium that is capable of transmitting a signal such as, for example, conductive wires, conductive traces, optical waveguides, or the like. The communication path 114 may also refer to the expanse in which electromagnetic radiation and their corresponding electromagnetic waves traverses. Moreover, the communication path 114 may be formed from a combination of mediums capable of transmitting signals. In one aspect, the communication path 114 comprises a combination of conductive traces, conductive wires, connectors, and buses that cooperate to permit the transmission of electrical data signals to components such as processors, memories, sensors, input devices, output devices, and communication devices. Accordingly, the communication path 114 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

Each of the one or more memory modules 113 of the vehicle 10 is coupled to the communication path 114 and communicatively coupled to the one or more processors 116. Each of the one or more memory modules 113 comprises non-transitory computer readable memory. The one or more memory modules 113 may comprise RAM, ROM, flash memories, hard drives, or any device capable of storing machine-readable instructions such that the machine-readable instructions can be accessed and executed by the one or more processors 116. The machine-readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine-readable instructions and stored on the one or more memory modules 113. Alternatively, the machine-readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Embodiments of the vehicle 10 include network interface hardware 101. The network interface hardware 101 can be communicatively coupled to the communication path 114 and can be any system or device capable of transmitting and/or receiving data. Accordingly, the network interface hardware 101 can include a communication transceiver for sending and/or receiving any wired or wireless communication. For example, the network interface hardware 101 may include an antenna, a modem, LAN port, Wi-Fi card, WiMax card, mobile communications hardware, near-field communication hardware, satellite communication hardware and/or any wired or wireless hardware for communicating with other networks and/or devices. The vehicle 10 may communicate, through the network interface hardware 101, with a network. The network may include one or more computer networks (e.g., a personal area network, a local area network, a server network, or a wide area network), cellular networks, satellite networks and/or a global positioning system and combinations thereof. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

Embodiments of the vehicle 10 include the one or more attitude sensors 102 or other sensors for detecting a vehicle angle at least along the vehicle's direction of motion. Each of the one or more attitude sensors 102 comprises, for example, an accelerometer arrangement having three sensitive axes nominally orthogonal to each other where a signal indicative of the acceleration along each of the sensitive axes is generated by the one or more attitude sensor 102. The accelerometer may comprise three accelerometers whose sensitive axes are not co-linear, most typically a set of three accelerometers arranged in a nominally orthogonal configuration, known as a triaxial accelerometer. In certain embodiments, the three accelerometers have a nonzero DC response such that when the sensor is at rest, the projection of the static gravitational acceleration vector onto each of the three accelerometers is measured. From these values, the pitch and roll of the attitude sensor and the magnitude of the gravitational acceleration vector can be determined. In some embodiments, only one accelerometer is used and its sensitive axis is parallel to the direction of forward or reverse motion of the vehicle 10.

As used herein, a sensitive axis refers to the axis along which a sensor is capable of sensing and generating a signal indicative of a vector having a magnitude and direction related to acceleration along that axis. The accelerometers or other sensors of the one or more attitude sensors 102 may comprise any device capable of generating a signal in response to acceleration along a sensitive axis, such as, without limitation, a bulk micromachined capacitive accelerometer, a bulk micromachined piezoelectric resistive accelerometer, a capacitive spring mass system, a micro electro-mechanical system (MEMS), or the like. In some embodiments, the one or more attitude sensors 102 may include an inertial measurement unit, a gyroscope, a magnetometer, or the like. The one or more attitude sensors 102 are communicatively coupled via the communication path 114 to the other systems of the vehicle 10.

In some embodiments, the one or more attitude sensors 102 comprise one or more fluid-based tilt sensors such as electrolytic tilt sensors. Electrolytic tilt sensors are mature, small, low power devices that are inherently free of bias drift. Fluid-based tilt sensors are used in a wide array of applications that demand highly repeatable tilt sensing, including seismic monitoring, avionics, construction, and solar tracking. The sensor is composed of a small container, typically made of glass, ceramic, or plastic, that houses electrically conductive fluid and a small air bubble. A number of electrodes protrude into the container, and as the sensor tilts, the air bubble moves, causing a change in impedance between the electrodes, which can be used to measure the angle of the sensor with high repeatability. Fluid-based tilt sensors may comprise one or more sensitive axes, such that the sensor measures the absolute rotational position about each sensitive axis. Fluid-based tilt sensors are available in small packages and can easily be integrated with an accelerometer onto a circuit board. Additionally, they are sensitive over limited ranges of roll and pitch.

Some embodiments of the vehicle 10 include a tachometer 104 and a speedometer 106. The tachometer 104 and the speedometer 106 may generate one or more signals to send to the transmission shifting ECU 100 regarding the current engine RPM and the vehicle speed. Other methods of measuring engine RPM and vehicle speed may generate a similar signal, such as the GPS and/or a transmission status relay. The one or more signals generated by the tachometer 104 and the speedometer 106 may determine whether or not the transmission shifting ECU 100 shifts the transmission 12 or not, such as, if the engine RPM is above a certain level, the transmission 12 will not downshift to avoid exceeding an RPM limit.

Some embodiments of the vehicle 10 include one or more brake meters 108. The brake meters 108 measure the force of the applied brakes and generate a signal to the transmission shifting ECU 100. In some embodiments, the transmission shifting ECU 100 may downshift the transmission based on an applied force as measured by the brake meters 108. Such a downshift might help slow the vehicle 10 when the brakes are being applied with a certain force. The brakes of the vehicle may be any type of vehicle brake to include rotary brakes, disc brakes, brakes by wire, electronic brakes, etc.

In some embodiments, the vehicle 10 includes a road condition sensor 118. In some embodiments, the road condition sensor 118 includes a camera or other sensor for determining the condition of the road surrounding the vehicle. Embodiments include sensors such as SONAR, RADAR, LIDAR, and other sensors suitable for detecting a surrounding environment. The one or more road condition sensors 118 may provide information to the transmission shifting ECU 100 for determining shift points. Additionally, some embodiments of the vehicle 10 include road condition updates from the GPS 110 or some other system that is capable of updating a road conditions signal in real time as inputs to the transmission shifting ECU 100 for determining whether to adjust shift points or not.

In some embodiments of the vehicle 10, the GPS 110 provides a location signal to the transmission shifting ECU 100. The location signal may prevent the transmission shifting ECU 100 from downshifting the transmission 12 when the vehicle 10 is within particular geographic locations. In one non-limiting example, the user may prefer that the transmission shifting ECU 100 not downshift the vehicle 10 when the user is within X miles from the user's home. By providing the GPS with the location of the user's home and a particular radius or geographic location to prevent shifting, the user might prevent shifting of the transmission on well-known or frequently travelled routes. As another example, some geographic locations regulate the use of engine braking. Thus, these geographic locations could be provided to the GPS 110 and the GPS could generate a signal to prevent shifting the transmission when the vehicle 10 is in such a location.

Some vehicles 10 and transmission shifting ECUs 100 include weather condition sensors 120 for sensing the weather conditions surrounding the vehicle 10. Embodiments of the vehicle 10 include barometers, thermometers, wind gauges, and other systems for determining weather conditions. In some embodiments, the transmission shifting ECU 100 may receive weather updates from the GPS 110 or some other system capable of broadcasting weather conditions. The weather condition sensors 120 may assist in determining shift points by, for example, determining whether icy road conditions exist such as to shift the transmission in order to initiate engine braking more readily.

One or more embodiments may include a transmission status relay 112. The transmission status relay 112 may transmit information regarding the current status of the transmission 12 to the other components of the vehicle 10 such as the transmission shifting ECU 100 or the one or more processors 116. Information regarding the current status of the transmission may include current gear ratio, current gear selected, current gear transmission status (e.g., in park (i.e., when the engine is not coupled to the transmission), in reverse, etc.) The transmission status relay 112 may prevent the transmission shifting ECU 100 from initiating engine braking if, for example, the vehicle is not in drive (for example, if the input shaft is not coupled to the transmission).

Some embodiments of the vehicle 10 allow a user to input user preferences for controlling the shift schedule or the operating characteristics of the transmission shifting ECU 100 using a user preferences module 103. The user preferences module 103 may comprise a touchscreen, such as a center console or other console within the vehicle, or any other means for inputting preferences into the vehicle. Some embodiments of the user preferences module 103 may be smartphone based, such as an app installed on a user's smart phone for inputting user shifting preferences or other data. For example, a user might enable or disable the transmission shifting ECU 100, or set the transmission shifting ECU 100 to automatically downshift when the vehicle is on a roadway that exceeds a certain grade. Some embodiments of the user preferences allow the user to prevent the transmission shifting ECU 100 from downshifting the transmission if a downshift would cause the engine to exceed a particular RPM or the speed of the vehicle 10 to reduce to a particular speed. In some embodiments of the system, the user may set the transmission shifting ECU 100 to downshift the vehicle 10 when the road grade exceeds a certain level. In some embodiments, the user may set the transmission shifting ECU 100 to downshift the vehicle 10 when the brake level exceeds a particular set point or if a collision detection system detects that a collision is possible. Users might set a particular sensing distance of the road condition sensors 118 or other sensors to activate the transmission shifting ECU 100 based on the output of the sensors.

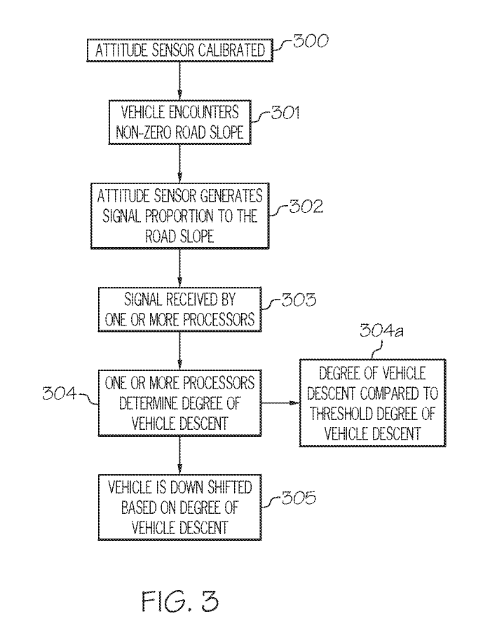

Referring now to FIG. 3, a flowchart for shifting a transmission based on vehicle attitude is shown. At block 300, the one or more attitude sensors 102 may be calibrated based on a zero degree road slope. The calibration may enable accurate measurement of later-encountered non-zero slopes. The calibration may occur at or prior to the sale or lease of a vehicle or before reaching the end user. In some cases, the calibration may occur at some time or various times over the effective life of the vehicle. Not all embodiments of the vehicle 10 or of the one or more attitude sensors 102 will require calibration. For example, if the one or more attitude sensors 102 are calibrated before inclusion in the vehicle 10 or if the one or more attitude sensors 102 are electrolytic tilt sensors. Thus, this step may not be performed in various embodiments described herein.

As shown by block 301, the vehicle 10 may subsequently encounter a non-zero road grade (i.e., a positive or negative road slope). Upon experiencing such a grade, the one or more attitude sensors 102 may output a signal proportional to the road slope as discussed above and shown by block 302.

As shown by block 303, the signal may be received by the one or more processors 116 through the communication path 114. The one or more processors 116 may then determine the degree of vehicle descent based on the magnitude of the signal received from the one or more vehicle attitude sensors as shown by block 304. In most cases, the determined vehicle descent will correspond with the slope of the road, and thus, the slope of the road is a factor for determining whether to downshift the vehicle to initiate engine braking or not. However, not all cases of a negative vehicle attitude will correspond with a negative road slope and so, as discussed above, the transmission shifting ECU 100 or the one or more processors 116 may receive additional inputs for determining whether or not to downshift the vehicle in order to initiate engine braking.

For example, it might be that in certain instances the vehicle 10 will encounter a negative grade but not have a positive forward velocity, such as, for example, when the vehicle is being towed, in a reverse gear, or during maintenance. During each of these examples, it is obviously not ideal for the transmission 12 to automatically downshift. Hence the additional inputs to the transmission shifting ECU 100 or one or more processors 116 such as the transmission status relay 112, the speedometer 106, and the GPS 110 may prevent the vehicle 10 from unnecessarily downshifting to initiate engine braking.

As shown by block 304a, in some embodiments, the transmission shifting ECU 100 or the one or more processors 116 may compare the degree of vehicle descent to a threshold degree of descent to determine whether to shift the transmission 12 to a lower gear or not. The threshold degree of descent may be calculated by the transmission shifting ECU 100 or the one or more processors 116. In some embodiments the threshold degree of vehicle descent may be stored in one or more of the memory modules 113, such as in a look up table, or may be provided by or calculated from info provided by the GPS 110 or other vehicle component. The threshold degree of vehicle descent may be based on the vehicle speed, the vehicle attitude, the weather conditions, the road slope as sensed by the one or more attitude sensors 102, a road slope as relayed by GPS 110, or some other means. In some embodiments, the current vehicle conditions may be compared to the expected vehicle conditions to determine if the threshold value is met or exceeded.

At block 305, the vehicle is downshifted based on the degree of vehicle descent. This may occur by generating one or more signals using the transmission shifting ECU 100 or the one or more processors 116 and sending a signal to the transmission 12 to downshift the transmission 12. Downshifting the transmission may increase the engine braking force thereby reducing the speed of the vehicle (i.e., decelerating) without the use of the friction brakes. Because the brakes are used less frequently and/or at a lesser magnitude, the brakes will wear less quickly resulting in a longer average life span. This may be particularly useful in hilly/mountainous areas where vehicles are routinely driven on down slopes.

In some embodiments, the transmission shifting ECU 100 or the one or more processors 116 may be configured to predict a predicted degree of vehicle descent based on the vehicle route planned into the GPS 110 or using some other method. The predicted degree of vehicle descent may be predicted from data associated with one or more routes in GPS, for example data including the slope of a road along a preplanned route in the GPS. The GPS may use maps stored in the one or more memory modules 113, downloaded in real time, or received or stored in the vehicle 10 using some other means now known or later developed to generate the route and/or predicted degree of vehicle descent. In such embodiments, the transmission shifting ECU 100 may be configured to shift the transmission 12 when the predicted degree of vehicle descent and the measured degree of vehicle descent exceed the threshold degree of vehicle descent.

In other embodiments, vehicle road grade may be determined, calculated, or predicted using other vehicle conditions such as GPS estimated trajectory, road images from a camera, torque, shock compression, speed, fuel consumption or the like. Additionally, in other embodiments, vehicle road grade may be calculated using methods of calculation currently known in the art or later developed, such as differential equations, linear equations or the like. In some embodiments, the road slope calculation may be based upon acceleration and pedal position. For example, the GPS 110 may provide a road grade based on one or more maps that are stored in the GPS 110 or on an external server and received through the network interface hardware 101 or some other means. This GPS-provided road grade may be sent via the communication path 114 to the transmission shifting ECU 100 and used to shift the transmission 12. In one or more embodiments, the GPS-provided road grade may be compared to the measured road grade to perform one or more functions. In embodiments of the vehicle 10 with one or more road condition sensors 118, such as one or more cameras, the road condition sensors 118 may use one or more algorithms, such as a photographic recognition software, alone or in combination with another component of the vehicle 10, to predict a road grade. The one or more road condition sensors 118 may send this prediction to the transmission shifting ECU 100 to compare to the measured road grade signal or to shift the transmission 12.

In some embodiments, the transmission shifting ECU 100 may be configured to determine a vehicle speed and to compare the vehicle speed to a threshold vehicle speed. The threshold vehicle speed may be stored in one or more of the memory modules 113, such as in a look up table, or may be provided by or calculated from info provided by the GPS 110 or some other component of the vehicle 10. In embodiments wherein the transmission shifting ECU 100 is configured to compare the determined vehicle speed to a threshold vehicle speed, the transmission 12 of the vehicle 10 may be downshifted in response to a comparison between the determined vehicle speed and the threshold vehicle speed. For instance, the transmission shifting ECU 100 may receive an input from the speedometer 106 or the tachometer 104 and the transmission status relay 112 to determine a vehicle speed. In some embodiments, the GPS 110 may send a signal to the transmission shifting ECU 100 that includes vehicle speed. If the transmission shifting ECU 100 determines that vehicle speed exceeds a threshold, programmed, or otherwise desired vehicle speed based on transmission shifting preferences for a given road grade, measured or otherwise, the transmission shifting ECU 100 may shift the transmission 12.

In some embodiments, the transmission shifting ECU 100 may be configured to calculate a predicted rotational velocity of the engine after a downshift, such as when the vehicle 10 initiates engine braking, based on the various gear ratios, present vehicle speed, present road grade, and other conditions that effect the rotational velocity of the engine. In such embodiments, the transmission shifting ECU 100 may compare the predicted rotational velocity of the engine to a threshold rotational velocity of the engine. The threshold rotational velocity may be stored in one or more of the memory modules 113, such as in a look up table, or may be provided by or calculated from info provided by some other component or components of the vehicle 10. In some embodiments, the transmission shifting ECU 100 may prevent a shift of the transmission 12 if the predicted rotational velocity of the engine is too high, such as if it would exceed a limit. Additionally, the predicted rotational velocity of the engine might be used to calculate a predicted decrease in vehicle speed after the shift. The transmission shifting ECU 100 may receive a signal from the brake meter 108 via the communication path 114 to determine such a decrease in speed. The decrease in speed could be used to calculate a resulting speed after the shift, which might be useful, such as, in embodiments having a user preferences module 103. The information might help users set their preferences for a given road grade and vehicle speed.

In some embodiments, the transmission shifting ECU 100 is configured to predict a predicted degree of vehicle descent based on the vehicle route and to downshift the transmission 12 if the determined degree of vehicle descent exceeds a threshold value and matches the predicted degree of vehicle descent. The predicted degree of vehicle descent may be generated by the GPS 110 or some other component of the vehicle 10 and be based on one or more maps associated with one or more vehicle routes. For example, a user may input an intended route into the GPS 110 to travel from point A to point B. The GPS 110 or the transmission shifting ECU 100 or some other appropriate component might predict one or more grades along the planned route. As the user drives the route, the GPS 110 may send a signal to the transmission shifting ECU 100 of the road grade and the transmission shifting ECU 100 may shift the transmission when that signal exceeds the threshold shifting signal. The threshold shifting signal may be set by the user using the user preferences module 103. In some embodiments, the GPS 110 may only send a signal to the transmission shifting ECU 100 when the threshold signal is exceeded.

In some embodiments, the transmission shifting ECU 100 is configured to determine a weather condition and a road condition and to downshift the transmission 12 based on, at least in part, the determined degree of vehicle descent, the weather condition, and/or the road condition. The weather condition may be generated by the vehicle 10, such as by the weather condition sensor 120 or be received by the vehicle by a component such as the GPS 110. Similarly, the road condition may be sensed and a signal generated by a component of the vehicle, such as the road condition sensor 118, or received by a component such as the GPS 110. For example, a user may desire to be limited to a certain speed when a road is wet or covered in precipitation. The user may use the user preferences module 103 to set various set points based on weather conditions such that the user preferences module 103 sends a signal to the transmission shifting ECU 100 when the road is wet as sensed by the one or more road condition sensors 118. Similarly, the one or more road condition sensors 118 may detect gravel or other foreign objects on the road and shift to a predefined lower threshold for shifting the transmission to ensure that the transmission 12 downshifts appropriately to maintain vehicle speed below user-defined limits.

In some embodiments, the vehicle 10 may determine a rate of change of vehicle attitude and determine whether to shift the transmission based upon the rate of change of vehicle attitude. For example, in certain instances, the vehicle attitude may decrease rapidly and subsequently slowly return to zero, such as when the road grade has a relatively large magnitude negative slope and then slowly begins to level off again. In such cases, a downshift may not be advantageous because the vehicle may be past the relatively large magnitude of negative road grade before the vehicle shifts gears. In such a case, the vehicle 10 may not downshift because, while the instantaneous degree of attitude may temporarily exceed a threshold value, the attitude will not exceed the threshold value for long. Based on the slope getting less negative in magnitude, the transmission shifting ECU 100 may withhold a signal to shift the transmission to initiate engine braking. Similarly, the transmission shifting ECU 100 may have one or more filters to filter out instantaneous, erroneous, or erratic signals that are erroneous or so temporally short that they do not merit a shift to a lower gear to initiate engine braking. The filter may be a component of the transmission shifting ECU 100 or some other component of the system. The filter may be adjustable, such as, for example, by setting a user preference of the system.

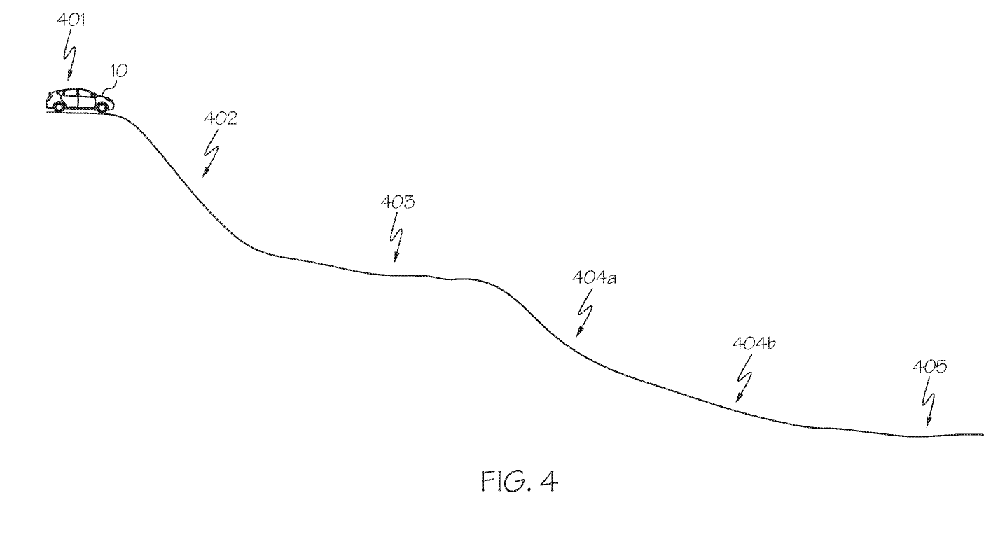

FIG. 4 shows a vehicle approaching a stretch of road having different slopes illustrated by sections 401-405 of the road. The vehicle 10 may include a transmission shifting ECU 100 configured to perform the engine braking functions as described herein. Of course, FIG. 4 is meant to demonstrate only one example of the infinite number of possible grades along different routes. The purpose is to demonstrate how the system works.

At section 401, the vehicle is on a flat section of road. The transmission shifting ECU 100 is configured to simply allow the transmission to operate normally. The shift settings of the transmission 12 are unaffected. However, as the vehicle 10 approaches section 402, the vehicle may downshift the transmission when the vehicle 10 senses the negative slope. In some embodiments, the GPS 110 may predict the upcoming road slope and generate a signal to the transmission shifting ECU 100 regarding the slope. In these embodiments, the vehicle 10 may shift the transmission 12 when the predicted slope is confirmed by the one or more attitude sensors 102. In this way, the one or more attitude sensors 102 can serve as a check on the GPS 110 and prevent unnecessary shifts of the transmission in the case of faulty or erroneous map data. Additionally, the transmission shifting ECU 100 may generate a signal to downshift the transmission 12 in preparation for the negative slope of section 402 while the vehicle 10 is still in section 401, shifting the transmission 12 to slow the vehicle 10 to at least partially preempt the effects of gravity that will accelerate the car down the negative slope.

As the vehicle 10 reaches section 403, the signal generated by the one or more attitude sensors 102 in proportion to the magnitude of the down slope dissipates and the transmission 12 shifts back to its normal gear for the given speed and acceleration. This may happen in a number of ways, for example, the transmission shifting ECU 100 may send a signal to shift the transmission 12 to a higher gear. Conversely, the transmission shifting ECU 100 may simply stop sending a signal to the transmission 12 to downshift the transmission.

Sections 404a and 404b further illustrate the functionality of the system. Section 404a has a noticeably larger negative slope than section 404b. Along the length of section 404a, one or more portions may have an instantaneous slope of which the magnitude may exceed the magnitude at which point the vehicle would downshift the transmission to initiate engine braking. However, in the example shown, section 404a is a relatively short portion of road. Because section 404a is followed by a section 404b with a relatively smaller magnitude slope, and because no instantaneous slope of section 404b is large enough to trigger a downshift, the transmission 12 may not downshift. In this example, the GPS 110 may send a signal to the transmission shifting ECU 100 to indicate that the magnitude of the negative slope will decrease before the vehicle reaches section 404a or while the vehicle 10 is in section 404a. This signal may effectively acknowledge that a downshift would only need to be immediately followed by an up shift and so would be largely ineffective at slowing the speed of the vehicle 10, so would only result in unnecessary shifting of the transmission.

Regardless of whether the vehicle 10 performs the transmission shifts as described above, at section 405, as the vehicle 10 again levels off, the transmission will shift back to its normal shift schedule given a desired speed and acceleration.

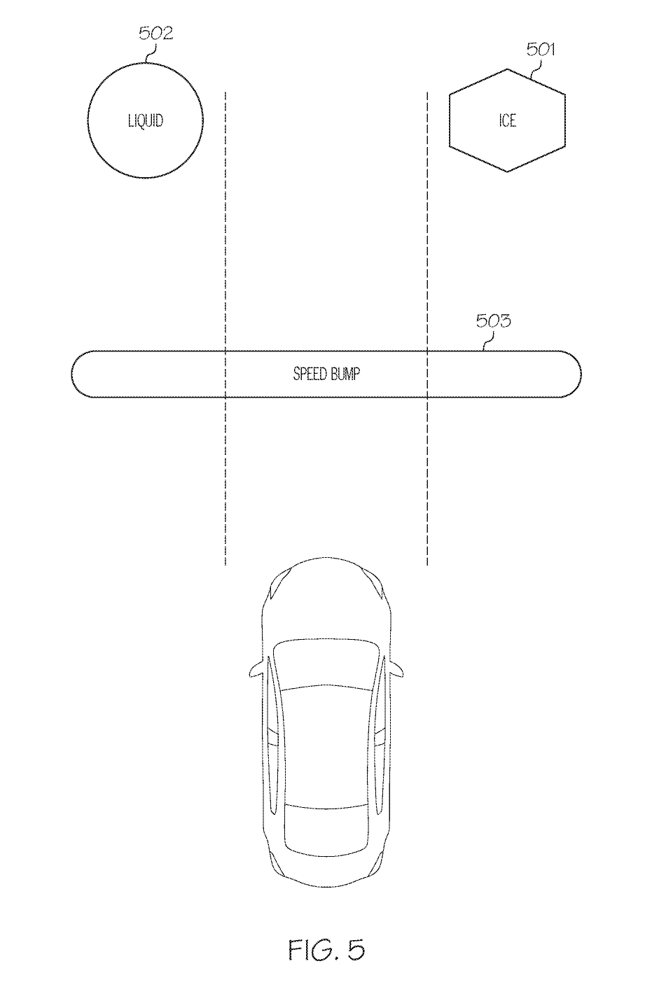

FIG. 5 shows the vehicle 10 encountering various external conditions that may or may not cause an initiation of engine braking as described herein, for example, ice 501. A single instance of ice along a roadway may indicate that other instances are possible as an instance of ice generally coincides with temperatures at or below freezing. Such conditions may require precautions such as limitations to speed. One way to limit speed is engine braking and so when external sensors, such as cameras or thermometers, detect conditions that are amenable to ice, the sensors may generate a signal to send to the transmission shifting ECU 100 causing the transmission shifting ECU 100 to shift the transmission to initiate engine braking.

Similarly, various sensors of the vehicle 10 may be configured to detect the presence of liquid 502, such as water or oil, on the roadway. As described above, the sensors may detect rain, moisture, humidity, or any other type of liquid in the air or on the ground. As with driving on an icy road, a prudent driver might reduce speed to better handle a wet road. The transmission shifting preferences described herein can be entered such that an automatic downshift will result more readily given the detection of liquid on the road. All things being equal, this will result to more engine braking under wet conditions and thus lower vehicle speeds and less wear on friction brakes and other braking systems.

Also shown in FIG. 5 is a speed bump 503. Speed bump 503 illustrates one possible source of erroneous readings for the gear shifting system described herein. Generally, four-wheeled vehicles will pass over a speed bump 503 one axle at a time. That is, the front wheels will climb and descend the speed bump and then the rear wheels will climb and descend the speed bump. Generally, when the rear wheels are on the speed bump and the front wheels are not, the vehicle will have a negative grade, that is, the rear wheels will be above front wheels and the vehicle will tilt forward. But embodiments of the transmission shifting system can avoid such erroneous results, such as, for example, by requiring a larger magnitude degree of vehicle descent prior to initiating the downshift, by filtering signals from the attitude sensors that are less than a certain magnitude, or by any other appropriate method.

Embodiments of the present disclosure are directed to vehicles, electronic control units, and methods for gear shifting based on vehicle attitude. In some embodiments, electronic control units may receive a signal from one or more vehicle attitude sensors, determine a degree of vehicle descent based on the signal received from one or more vehicle attitude sensors, and downshift the vehicle transmission based on the degree of vehicle descent determined based on the signal received from one or more vehicle attitude sensors, thereby resulting in less brake wear and allowing the use of smaller brake components, which reduces vehicle weight.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle comprising:
an engine;
a plurality of drive wheels;
a vehicle transmission configured to transmit power from the engine to the plurality of drive wheels;
one or more vehicle attitude sensors; and
an electronic control unit communicatively coupled to the one or more vehicle attitude sensors and the vehicle transmission, wherein the electronic control unit is configured to:
receive a signal from the one or more vehicle attitude sensors;
determine a degree of vehicle descent based on the signal received from the one or more vehicle attitude sensors; and
downshift the vehicle transmission based on the degree of vehicle descent determined based on the signal received from the one or more vehicle attitude sensors.

2. The vehicle of claim 1, wherein the electronic control unit is further configured to downshift the vehicle transmission when the determined degree of vehicle descent exceeds a threshold degree of descent.

3. The vehicle of claim 2, wherein the electronic control unit is further configured to:
predict a predicted degree of vehicle descent based on a vehicle route; and
downshift the vehicle transmission when the predicted degree of vehicle descent and the measured degree of vehicle descent exceeds the threshold degree of vehicle descent.

4. The vehicle of claim 1, wherein the electronic control unit is further configured to:
determine a vehicle speed;
compare the determined vehicle speed to a threshold vehicle speed; and
downshift the vehicle transmission in response to comparing the determined vehicle speed to the threshold vehicle speed.

5. The vehicle of claim 1, wherein the electronic control unit is further configured to:
calculate a predicted rotational velocity of the engine after the downshift;
compare the predicted rotational velocity of the engine to a threshold rotational velocity of the engine; and
downshift the vehicle transmission in response to comparing the predicted rotational velocity of the engine to the threshold rotational velocity of the engine.

6. The vehicle of claim 1, wherein the electronic control unit is further configured to:
predict a predicted degree of vehicle descent based on a vehicle route; and
downshift the vehicle transmission if the determined degree of vehicle descent exceeds a threshold value and matches the predicted degree of vehicle descent.

7. The vehicle of claim 1, wherein the electronic control unit is further configured to:
determine at least one of a weather condition and a road condition; and
downshift the vehicle transmission based on the determined degree of vehicle descent and the determined at least one of the weather condition and the road condition.

8. An electronic control unit for a vehicle, wherein the electronic control unit of the vehicle is configured to:
receive a signal from one or more vehicle attitude sensors;
determine a degree of vehicle descent based on the signal received from the one or more vehicle attitude sensors; and
downshift a vehicle transmission based on the degree of vehicle descent determined based on the signal received from the one or more vehicle attitude sensors.

9. The electronic control unit of claim 8 further configured to downshift the vehicle transmission when the determined degree of vehicle descent exceeds a threshold degree of descent.

10. The electronic control unit of claim 9 further configured to:
predict a predicted degree of vehicle descent based on a vehicle route; and
downshift the vehicle transmission when the predicted degree of vehicle descent and the measured degree of vehicle descent exceeds the threshold degree of vehicle descent.

11. The electronic control unit of claim 8 further configured to:
determine a vehicle speed;
compare the determined vehicle speed to a threshold vehicle speed; and
downshift the vehicle transmission in response to comparing the determined vehicle speed to the threshold vehicle speed.

12. The electronic control unit of claim 8 further configured to:
calculate a predicted rotational velocity of an engine after the downshift;
compare the predicted rotational velocity of the engine to a threshold rotational velocity of the engine; and
downshift the vehicle transmission in response to comparing the predicted rotational velocity of the engine to the threshold rotational velocity of the engine.

13. The electronic control unit of claim 8 further configured to:
predict a predicted degree of vehicle descent based on a vehicle route; and
downshift the vehicle transmission if the determined degree of vehicle descent exceeds a threshold value and matches the predicted degree of vehicle descent.

14. The electronic control unit of claim 8 further configured to:
determine at least one of a weather condition and a road condition; and
downshift the vehicle transmission based on the determined degree of vehicle descent and the determined at least one of the weather condition and the road condition.

15. A method of downshifting a vehicle transmission configured to transmit power from an engine to a plurality of drive wheels, the method comprising:
receiving a signal from one or more vehicle attitude sensors;
determining a degree of vehicle descent based on the signal received from the one or more vehicle attitude sensors; and
downshifting the vehicle transmission based on the degree of vehicle descent determined based on the signal received from the one or more vehicle attitude sensors.

16. The method of claim 15, wherein the vehicle transmission is downshifted when the determined degree of vehicle descent exceeds a threshold degree of descent.

17. The method of claim 16, further comprising:
predicting a predicted degree of vehicle descent based on a vehicle route; and
downshifting the vehicle transmission when the predicted degree of vehicle descent and the measured degree of vehicle descent exceeds the threshold degree of vehicle descent.

18. The method of claim 15, further comprising:
determining a vehicle speed;
comparing the determined vehicle speed to a threshold vehicle speed; and
downshifting the vehicle transmission in response to comparing the determined vehicle speed to the threshold vehicle speed.

19. The method of claim 15, further comprising:
calculating a predicted rotational velocity of the engine after the downshift;
comparing the predicted rotational velocity of the engine to a threshold rotational velocity of the engine; and
downshifting the vehicle transmission in response to comparing the predicted rotational velocity of the engine to the threshold rotational velocity of the engine.

20. The method of claim 15, further comprising:
predicting a predicted degree of vehicle descent based on a vehicle route; and
downshifting the vehicle transmission if the determined degree of vehicle descent exceeds a threshold value and matches the predicted degree of vehicle descent.
